(19) United States
(12) Patent Application Publication
(10) Pub. No.: US 2006/0026994 A1
(43) Pub. Date: Feb. 9, 2006

(54) Method and device for reinforcing glass pane by rapid cooling

(75) Inventor: Hideo Yoshizawa, Osaka-shi (JP)

Correspondence Address: HAMRE, SCHUMANN, MUELLER & LARSON, P.C., P.O. BOX 2902-0902, MINNEAPOLIS, MN, 55402, US

(73) Assignee: Nippon Sheet Glass Co., Ltd., Osaka (JP)

(21) Appl. No.: 10/537,734

(22) PCT Filed: Nov. 21, 2003
(86) PCT No.: PCT/JP03/14881

§ 371 Date: Jun. 7, 2005

(30) Foreign Application Priority Data
Dec. 25, 2002 (JP) 2002-374890

(51) Int. Cl. C03B 27/00; C03B 27/044

(52) U.S. Cl. 65/114; 65/349

(57) ABSTRACT

A method for quenching a glass sheet comprises the steps of radiating a microwave (46) at least on one surface of the glass sheet (G), and simultaneously air-quenching the glass sheet for tempering, wherein the microwave is radiated at the glass sheet through a gap (44) between adjacent air ducts (41A, 41A or 41B, 41B), and the quenching air is blown without hitting a plurality of conveying rollers (11) for conveying the glass sheet.

### TECHNICAL FIELD

This invention relates to a quenching method and apparatus for a flat toughened glass sheet.

### BACKGROUND ART

Obtaining a toughened glass sheet by quenching a heated glass sheet by blowing a cooling medium such as air at it has been known. Various heating means for this have been used, and in recent years, as one of these, a quenching apparatus using microwaves has been proposed, in U.S. Pat. No. 5,827,345. This quenching apparatus is shown in FIG. 12 hereof.

In FIG. 12, a quenching apparatus 100 has a waveguide 111, a housing 112, a door 113, upper and lower air blowing pipes 114, 115, and an arm 116. The reference number 110 denotes a glass sheet.

With the quenching apparatus 100, toughened glass is obtained by raising the door 113, feeding a glass sheet 110 placed on the arm 116 into the housing 112, heating the glass sheet 110 with microwaves supplied through the waveguide 111, and simultaneously cooling it by blowing air onto the glass sheet 110 through the upper and lower air blowing pipes 114, 115.

Thus the quenching apparatus 100 shown in FIG. 12 is a glass sheet quenching apparatus that utilizes microwaves. However, because the upper air blowing pipes 114 cover the upper side of the glass sheet 110, microwaves are blocked by the upper air blowing pipes 114, and a sufficient amount of microwaves does not reach the glass sheet 110. Consequently, the desired toughened glass is not obtained.

Normally, as the arm 116 supporting the glass sheet 110, one that supports the glass sheet 110 by supporting the edge parts of the glass sheet 110 is employed. In this case, the central part of the glass, which is not being supported, bends under its own weight. Therefore, for toughening a flat glass sheet of which accurate flatness is required, it can be said that the quenching apparatus 100 of related art shown in FIG. 12 is not suitable.

And, when with this quenching apparatus 100 an attempt is made to raise the cooling capacity, the air blowing pipes become large, they block the microwaves, and good quenching cannot be carried out.

Accordingly, a quenching apparatus has been awaited with which, having heating with microwaves as a premise, it is possible to raise both the cooling capacity and the heating capacity in quenching. In particular, the manufacturing of thin-sheet toughened glass, which requires strong cooling, has been awaited.

### DISCLOSURE OF THE INVENTION

This invention provides a glass sheet quenching method including: a step of heating a glass sheet on carrying rollers to a predetermined temperature in a heating furnace; a step of radiating scattered microwaves or converged microwaves onto one side or both sides of the glass sheet through gaps between adjacent multiple air ducts of a quenching apparatus disposed with a substantially uniform spacing with respect to a carrying direction of the glass sheet; and a blowing step of, simultaneously with the radiation of the microwaves, blowing cooling air onto one side or both sides of the glass sheet from the multiple air ducts, without hitting the carrying rollers.

Thus in the method of this invention, the temperature of the center of the glass sheet thickness is raised by heating with microwaves. And by cooling with cooling air, the temperatures of the surfaces of the glass sheet are lowered. As a result, a large temperature difference arises between the surfaces and the center, and even a thin glass sheet can be made a toughened glass sheet. At this time, because air cooling of the glass sheet is carried out with air ducts while microwaves are radiated through gaps between the adjacent air ducts, microwave heating and air cooling can both be carried out simultaneously.

Also, in the method of this invention, because the glass sheet is processed while it is being moved forward on carrying rollers, the flatness of the glass sheet can be maintained, and it is possible to produce a flat toughened glass sheet of high quality. That is, by scattered microwaves being used, they can be radiated through the gaps between adjacent air ducts, and uniform heating of the glass sheet becomes possible. The scattered microwaves are microwaves scattered by repeated reflection, and by repeated reflection a level of irradiation can be secured even of parts in the shadows of obstructions.

In the method of this invention, preferably, the frequency of the microwaves is 18 GHz to 300 GHz. At less than 18 GHz, arcing to metal parts constituting casings and so on occurs. And more than 300 GHz, a special microwave oscillator is needed, and it becomes extremely expensive. Accordingly, to keep down apparatus costs while also suppressing the occurrence of arcing, the frequency of the scattered microwaves is made in the range 18 GHz to 300 GHz.

For the production of microwaves of this frequency, an oscillator called a gyrotron can be used to good effect. As microwave oscillators, besides this, although there is the magnetron and the klystron, the gyrotron, whose practical oscillation frequency is 11 to 300 GHz, is ideal.

The converged microwaves used in the method of the invention, preferably, are scan-type converged microwaves scanned by means of an oscillating mirror. With an oscillating mirror, a microwave beam can be radiated uniformly onto a glass sheet. As a result, while it is a beam, it can heat a glass sheet of a large area uniformly along with the advancing of the glass sheet.

Preferably, the converged microwaves are band-like converged microwaves focused into a band of a length equivalent to the width of the glass sheet. That is, the glass sheet is irradiated with band-like microwaves. Because an oscillating mirror is unnecessary, there ceases to be any need to worry about trouble such as defective operation of the oscillating mirror.

The thickness of the glass sheet used in the method of the invention, preferably, is 1.2 mm to 2.5 mm. When the thickness of the glass sheet is less than 1.2 mm the temperature difference between the central part of the thickness and the surfaces is insufficient even when irradiation with microwaves is carried out, and manufacturing toughened glass becomes problematic. If it is a thick glass sheet such that the thickness of the glass sheet exceeds 2.5 mm, a temperature difference arises relatively easily, and an existing quenching apparatus is adequate, and there is no need to use the quenching method of the present invention. Accordingly, the method of this invention is preferably applied to a glass sheet of a thickness of 1.2 mm to 2.5 mm.

The invention also provides a glass sheet quenching apparatus installed downstream of a heating furnace for heating a glass sheet traveling on carrying rollers to a predetermined temperature, the glass sheet quenching apparatus having: a chamber that is substantially dome-shaped and has its inner surface made a reflecting surface above and/or below the glass sheet; a reflector provided in the vicinity of the center of the dome; a waveguide provided in the chamber for guiding microwaves toward the reflector; and multiple air ducts having between them gaps for allowing microwaves to pass through, disposed with a substantially uniform spacing in the travel direction of the glass sheet, for cooling with air the upper side and/or the lower side of the glass sheet, wherein the microwaves are radiated onto the glass sheet by the microwaves being primarily reflected with the reflector and secondarily reflected with the inner surface of the dome-shaped chamber.

Thus, in the apparatus of this invention, microwaves are primarily reflected with a reflector and secondarily reflected with the inner surface of a dome-shaped chamber. Because the reflector is mounted approximately at the center of the dome, microwaves having been secondarily reflected are incident on the face of the glass sheet substantially perpendicularly as they are radiated onto the glass sheet. Therefore, it is possible to heat the glass sheet effectively.

The reflecting surface of the chamber of this apparatus of the invention preferably is an irregularly reflecting surface, the primary reflection is reflection toward the inner surface of the chamber, and the secondary reflection is irregular reflection. That is, the microwaves are reflected by the reflector and directed toward the inner surface of the chamber and then irregularly reflected by the inner surface of the chamber. The microwaves approach the glass sheet in an irregularly reflected state. Because they are irregularly reflected, the microwaves can be radiated to every corner of the glass sheet, and the glass sheet can be heated effectively.

The reflector preferably has rotating means for rotating it about the center axis of the waveguide. By the reflector being rotated, it is possible first to cause microwaves to be reflected uniformly by the inside of the chamber, to add an effect of repeated reflection after that, and thereby to heat the glass sheet more uniformly.

Preferably, lower air ducts among the multiple air ducts of the apparatus of the invention are disposed directly below the carrying rollers, the lower air ducts each have multiple nozzles, and the multiple nozzles are disposed so that air blown out of them does not hit the carrying rollers. By disposing lower air ducts directly below the carrying rollers, it is possible to radiate microwaves onto the glass sheet through between the lower air ducts and between the carrying rollers. Accordingly, it is possible to suppress falling of the efficiency of the heating with microwaves.

Also, it is not desirable for air blown from the lower air ducts to hit the carrying rollers. So, a construction is adopted such that the air blown using the nozzles does not hit the carrying rollers. As a result, the lower side of the glass sheet can be cooled effectively with the lower air ducts.

### BRIEF DESCRIPTION OF THE DRAWINGS

FIG. 1 is a schematic view of a toughened glass manufacturing apparatus using a quenching apparatus according to the invention;

FIG. 2 is a detailed sectional view of a quenching apparatus according to the invention shown in FIG. 1;

FIG. 3 is a sectional view on the line 3-3 in FIG. 2;

FIG. 4 is a sectional view on the line 4-4 in FIG. 2;

FIG. 5 is an enlarged sectional view of the part 5 in FIG. 2;

FIG. 6 is a view in the direction of the arrows on the line 6-6 in FIG. 5;

FIG. 7 is a view showing reflection of microwaves radiated in a quenching apparatus of the invention;

FIG. 8A is a view showing radiation of microwaves having directionality and FIG. 8B a view showing scattered radiation of microwaves;

FIG. 9 is a sectional view showing the inside of a chamber having an irregularly reflecting surface;

FIG. 10 shows an example of another embodiment of a quenching apparatus, wherein heating is carried out by converged microwaves reflected by an oscillating mirror provided in a chamber;

FIG. 11 is a view showing an example of a chamber formed as a polyhedron; and

FIG. 12 is a view showing a quenching apparatus of related art.

### BEST MODES FOR CARRYING OUT THE INVENTION

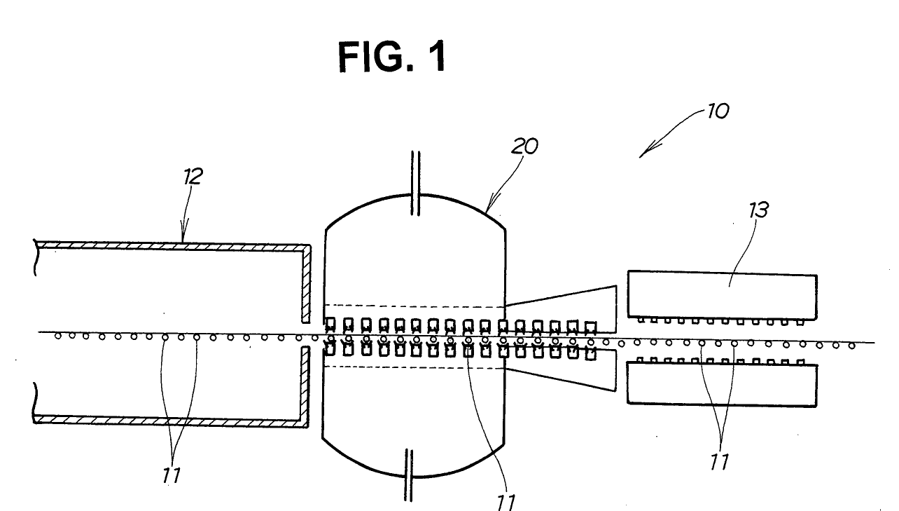

A toughened glass manufacturing apparatus 10 shown in FIG. 1 has multiple carrying rollers 11 for carrying a glass sheet horizontally, a heating furnace 12 for heating the glass sheet to a predetermined temperature, a glass sheet quenching apparatus 20 disposed downstream of the heating furnace 12 and including a primary cooling apparatus, and a secondary cooling apparatus 13 disposed downstream of the quenching apparatus 20.

The predetermined temperature is a temperature at which the glass sheet can be quenched. In this embodiment, the glass sheet is heated with microwaves in the course of the quenching.

In the quenching apparatus 20, toughening is carried out by a temperature difference being created between a central part of the glass sheet in its thickness direction and its surfaces by the central part of the glass sheet in its thickness direction being heated by microwaves to a temperature required for toughening while the surfaces of the glass sheet are cooled with air.

Because the glass sheet is at a high temperature and contains residual heat after residual stresses from toughening are created, it is fully cooled in the secondary cooling apparatus 13. Because the secondary cooling apparatus 13 can be a simple air-cooling apparatus, a description of its construction will not be given here.

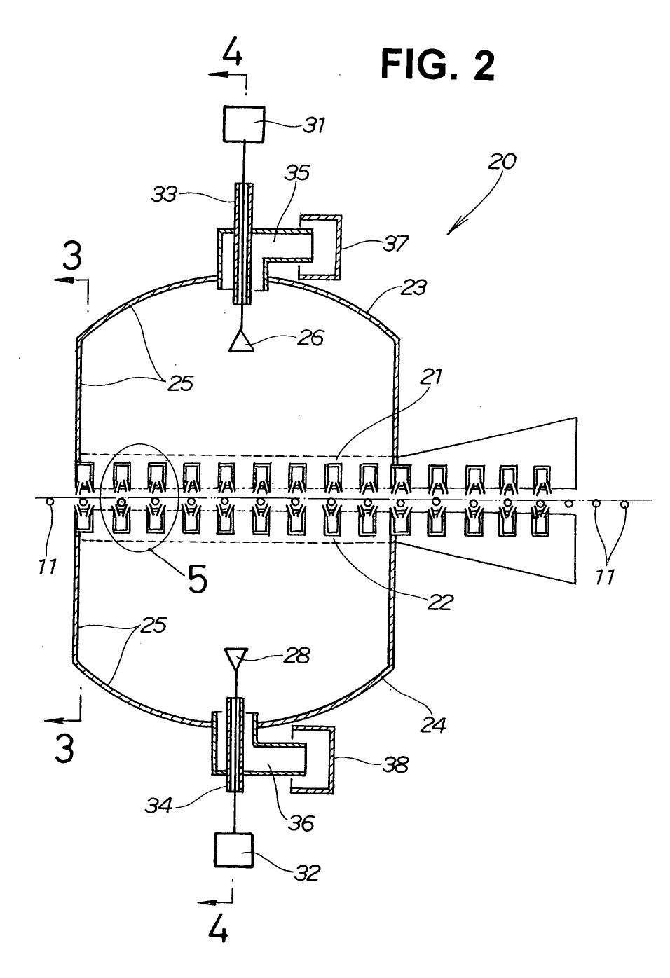

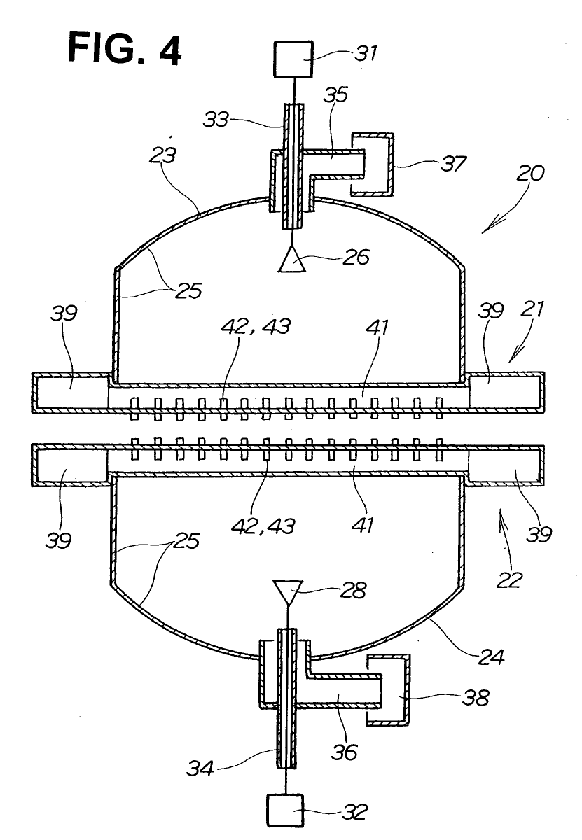

As shown in FIG. 2 and FIG. 4, the quenching apparatus 20 has an upper air blowing unit 21 and a lower air blowing unit 22 and an upper chamber 23 and a lower chamber 24 respectively covering these. The chambers 23, 24 are dome-shaped and their internal surfaces are reflecting surfaces 25, 25. Reflectors 26, 28 are disposed in the vicinities of the centers of the domes. These reflectors 26, 28 are rotated with rotating means 31, 32. Upper and lower waveguides 33, 34 are connected to the chambers 23, 24. Exhaust pipes 35, 36 extend from the chambers 23, 24. The outlets of these exhaust pipes 35, 36 are covered by safety covers 37, 38.

Because large quantities of air are blown into the chambers 23, 24 by the air blowing units 21, 22, the internal pressures of the chambers 23, 24 rise. To deal with this, the exhaust pipes 35, 36 are provided so that the air blown in can be exhausted to outside the chambers 23, 24 by the exhaust pipes 35, 36. Exhaust fans may be provided in the exhaust pipes 35, 36 to effect exhausting forcibly.

Because microwaves leak through the exhaust pipes 35, 36, the safety covers 37, 38 are provided to prevent operators and workers from being directly exposed to microwaves.

It is preferable for the waveguides 33, 34 to project by a fixed length into the chambers 23, 24. This is because by projecting by a fixed length they can suppress the excessive spreading of microwaves and effectively direct the microwaves guided into the chambers 23, 24 through the waveguides 33, 34 at the reflectors 26, 28. The fixed length is preferably a length reaching to points mid-way between the chambers 23, 24 and the reflectors 26, 28.

The reflectors 26, 28 are preferably polyhedrons. Also, the reflectors 26, 28 are preferably rotated about the center axes of the waveguides 33, 34 by rotating means 31, 32 such as motors with speed-reducers. This is because by this means it is possible to make the radiation of microwaves uniform.

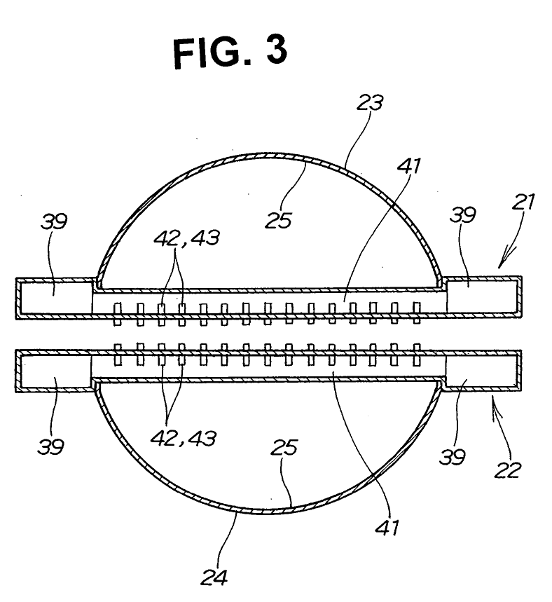

As shown in FIG. 3 and FIG. 4, the entrance (and exit) of the quenching apparatus 20 are cut sections of the chambers 23, 24 and are semi-circular sections. Because of this, microwaves reflected by the cut sections and the reflecting surfaces 25, 25 are reflected repeatedly inside the chambers.

The upper air blowing unit 21 is made up of a plurality of side ducts 39, 39 extending in the front-rear direction of the figures, air ducts 41 running between these side ducts 39, 39, and multiple nozzles 42, 43 fitted to these air ducts 41. To make uniform cooling possible, the multiple air ducts are disposed with a substantially uniform spacing.

The lower air blowing unit 22 also has the same construction as the upper air blowing unit 21.

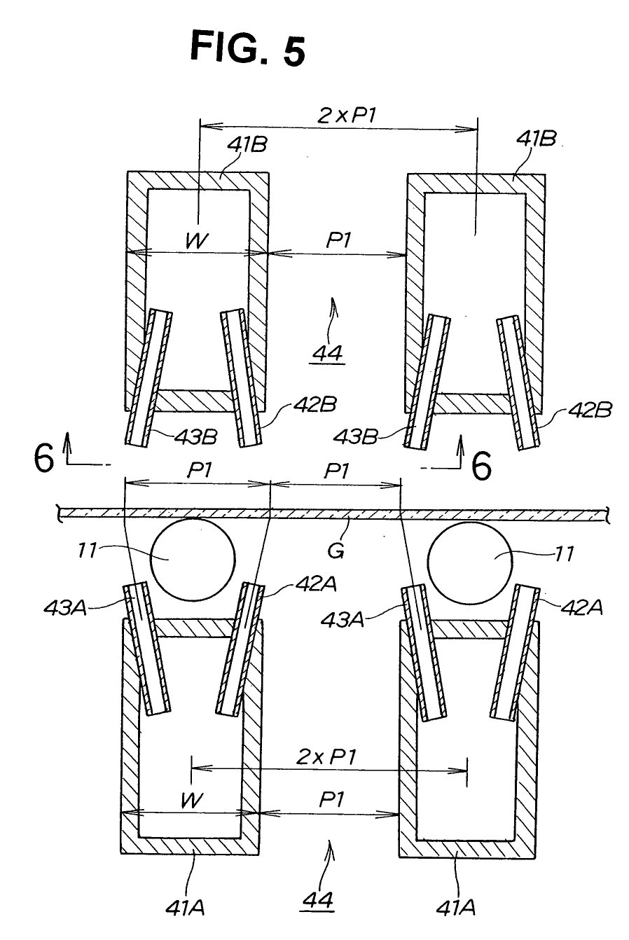

As shown in FIG. 5, a lower air duct 41A is disposed directly below a carrying roller 11. When looked up at from below, the carrying roller 11 is behind the lower air duct 41A and cannot be seen. That is, microwaves directed at the glass sheet G from below do not strike the carrying roller 11.

An inclined front nozzle 42A and an inclined rear nozzle 43A are provided in the lower air duct 41A so that air blown from these nozzles 42A, 43A reaches the glass sheet G directly, without striking the carrying roller 11.

To make uniform cooling possible by focusing on cooling center points of cooling air in the glass sheet G, the nozzles 43A, 42A are disposed so that the pitch of the center points is a substantially equal spacing of a fixed P1.

The pitch of the lower air ducts 41A, 41A is made 2×P1. If the width W of each lower air duct 41A is made the same as the pitch P1, a gap 44 of a length P1 can be provided between the air ducts 41A, 41A.

The upper air ducts 41B, 41B are disposed symmetrically (line-symmetrically) with the lower air ducts 41A, 41A across the glass sheet G. Accordingly, a gap 44 of a length P1 can be provided between the air ducts 41B, 41B also.

The internal pressure of the air ducts 41A, 41B is held at a high pressure 30000 Pa or more, preferably 50000 Pa. The reason for making it a high pressure like this is to minimize the width W of the air ducts 41A, 41B.

If air is blown at the glass sheet G with nozzles 42A, 43A and 42B, 43B disposed upper-lower symmetrically about the glass sheet G like this, the downward forces and the upward forces cancel out, and there is no risk of the glass sheet G floating upward.

The air supplied to the air ducts 41A, 41B is preferably dry air. This is because moist air includes water vapor, and water vapor absorbs microwaves and attenuates them. To this end, dry air with a dew point 20° C. or less and preferably 5° C. or less is used as the air.

To obtain this dry air, although moisture desorption with a desiccant is common, a method using a compressor is also effective. That is, in a compressor, along with the compressing operation, water in air condenses, and is removed as drainage. Therefore, by means of a compressor it is possible to achieve both pressurization of air and water-removal.

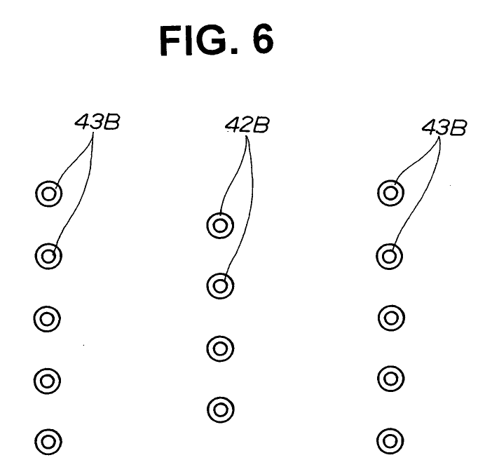

FIG. 6 shows front nozzles 42B and rear nozzles 43B disposed in zigzags. By this means it is possible to cool the glass sheet uniformly.

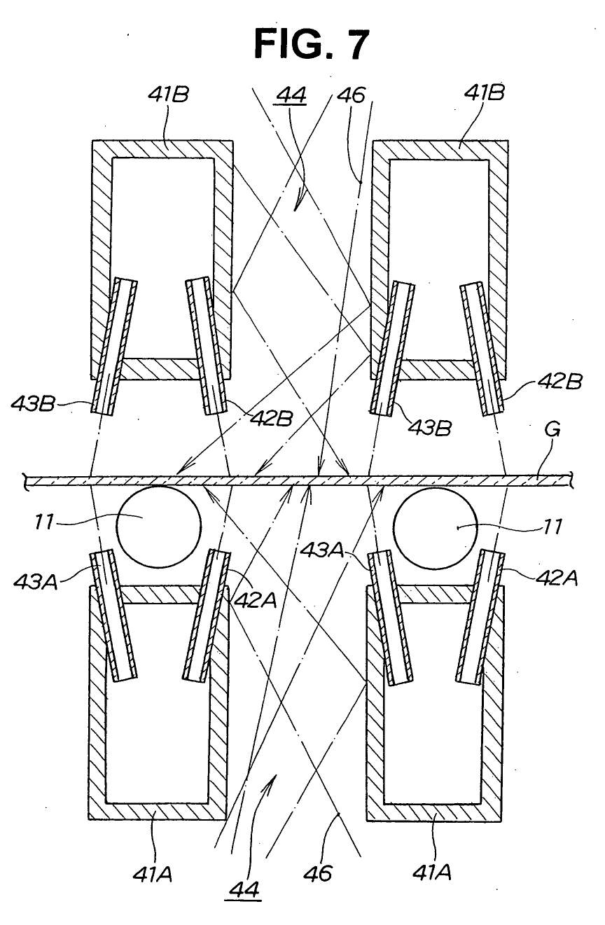

FIG. 7 shows radiation paths of microwaves in a quenching apparatus according to the invention. A considerable number of microwaves 46 reach the glass sheet G through the gap 44 between the lower air ducts 41A, 41A and the gap 44 between the upper air ducts 41B, 41B. The air ducts 41A, 41B are made of stainless steel, and their external surfaces can be made reflecting surfaces by being mirror-finished. As a result, some of the microwaves reach the glass sheet G after striking the air ducts 41A, 41B.

As a result of gaps 44, 44 of a width substantially equal to the width W (see FIG. 5) of the air ducts 41A, 41B being provided between the lower air ducts 41A, 41A and between the upper air ducts 41B, 41B like this, most of the microwaves 46, 46 reach the glass sheet G. And as a result of the external surfaces of the air ducts 41A, 41B being made reflecting surfaces like this, the number of microwaves 46 reaching the glass sheet G increases.

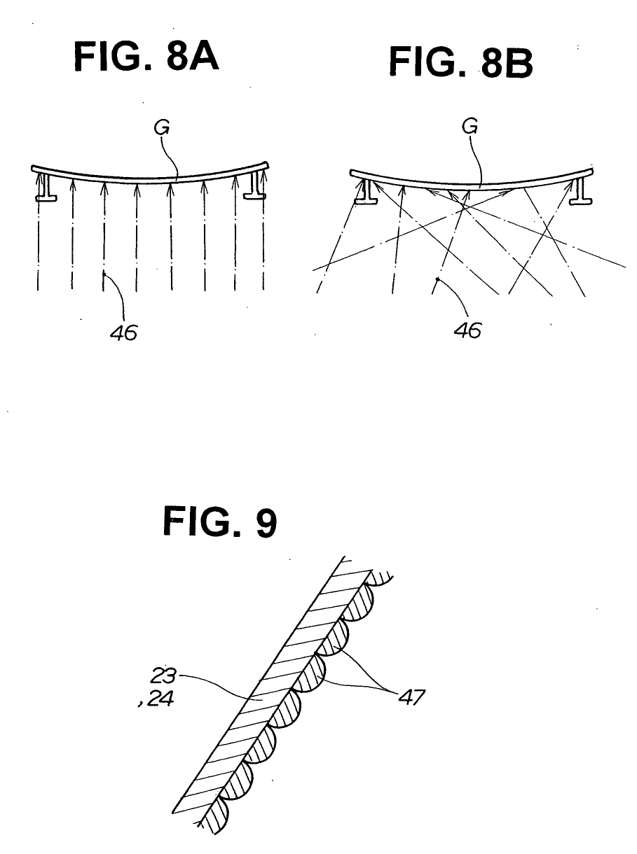

FIG. 8A and FIG. 8B show states of microwave radiation. FIG. 8A shows radiation of directional microwaves 46, and FIG. 8B shows radiation of scattered microwaves.

If dome-shaped chambers are employed and reflectors are positioned in the vicinities of the centers of the domes, as shown in FIG. 2, microwaves 46 can be radiated onto the faces of the glass sheet G uniformly.

This embodiment aims for radiation which is both uniform and scattered. To achieve that form, repeated reflection inside the chambers is effective, and irregularly reflecting surfaces work even more effectively.

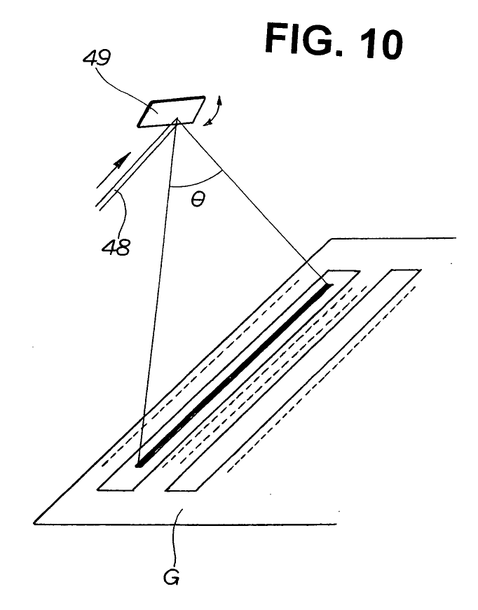

FIG. 9 shows an example of an irregularly reflecting surface. By providing multiple hemispherical reflectors 47 on the internal surfaces of the chambers 23, 24 it is possible to make them irregularly reflecting surfaces.

If the microwaves are reflected irregularly with irregularly reflecting surfaces, because the microwaves are repeatedly reflected inside the chambers, the chambers 23, 24 do not necessarily have to be made dome-shaped or spherical, and may alternatively be box-shaped.

In the embodiment described above, microwaves radiating in the order Waveguide→Reflector→Reflecting Surface→Glass Sheet and microwaves radiating in the order Waveguide→Reflector→Irregularly Reflecting Surface→Glass Sheet were discussed. However, besides those, microwaves can also be radiated onto the glass sheet in the following way.

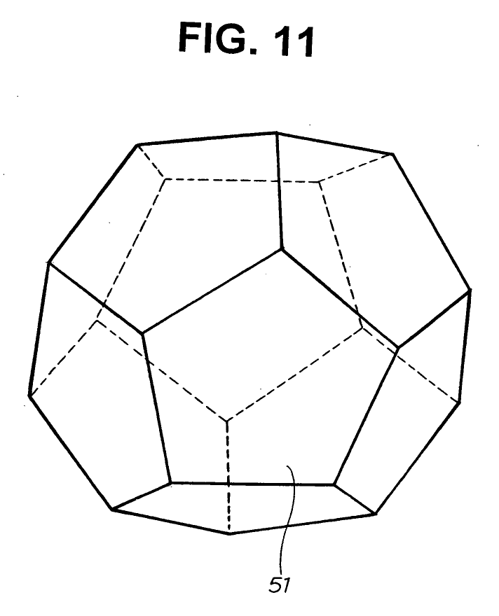

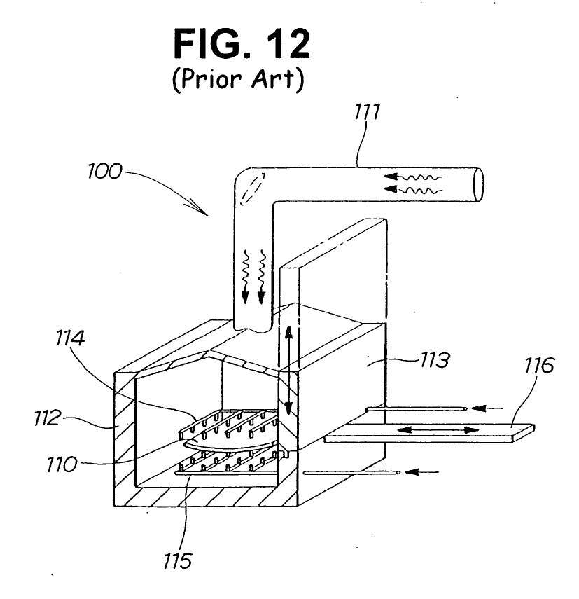

FIG. 10 shows another embodiment of radiating microwaves, and shows an example in which an oscillating mirror and converged microwaves are combined.

A converged microwave beam 48 is a beam obtained by using a reflecting converging system made up of quasi-optical reflecting mirrors to converge microwaves generated with an electromagnetic wave generator.

The converged microwaves 48 are reflected by an oscillating mirror 49 provided in the chamber, and heat up the glass sheet G in strips. θ is the angle of oscillation of the oscillating mirror 49. Because this oscillation angle θ can be changed freely, it is possible to adapt easily when for example the width of the glass sheet G has changed. Because the energy density of the converged microwave beam 48 is very high, for example if a variation is applied to the oscillation rate to make it slower at a central part of the glass sheet G and faster at edge parts, it is possible to heat the central part more strongly than the other parts.

Although it is not illustrated in the figures, by using a curved mirror it is possible to substitute a band-shaped beam for the converged microwave beam. The oscillating mirror of FIG. 10 can also be replaced with a fixed curved mirror to the same effect. In this case, the glass sheet can be heated with a converged microwave beam in the form of a band.

If converged microwaves are employed, because reflectors become unnecessary and it is also unnecessary for the chambers to be made dome-shaped, it is possible to simplify the construction of the quenching apparatus.

However, even when converged microwaves are employed, it is effective to make the chambers dome-shaped or make the inner surfaces of the chambers irregularly reflecting surfaces with the object of re-reflecting converged micro-waves reflected by the glass sheet and directing them back toward the glass sheet.

FIG. 11 shows another embodiment of a chamber. Besides a dome-shape, the chambers 23, 24 shown in FIG. 2 may alternatively be made a regular dodecahedron as shown in FIG. 11 or a polyhedron similar to this. Whereas with a dome shape the costs of fabrication mount up, with a polyhedron, because it is a combination of flat plates, the fabrication costs can be reduced.

And although in the embodiment described above an example of a quenching apparatus in which upper and lower chambers were provided was shown, it is also possible to achieve the same effects with an upper chamber only or a lower chamber only.

For the microwaves, a frequency of 18 GHz to 300 GHz is used. At less than 18 GHz, arcing to metal parts constituting casings and so on occurs. And more than 300 GHz, a special microwave oscillator is needed, and it becomes extremely expensive. Accordingly, to keep down apparatus costs while also suppressing the occurrence of arcing, the frequency of the scattered microwaves is preferably in the range 18 GHz to 300 GHz.

Although the glass sheet may be of any thickness, this embodiment is preferably applied to a glass sheet of 1.2 mm to 2.5 mm. At less than 1.2 mm the temperature difference between the center and the surfaces of the glass sheet is insufficient even when irradiation with microwaves is carried out, and manufacturing toughened glass becomes difficult. And to quench a thick glass sheet of more than 2.5 mm with the apparatus of this embodiment is uneconomic costwise.

### INDUSTRIAL APPLICABILITY

The method and apparatus of the present invention are not limited to toughened glass sheets for automotive vehicles and are also useful in the manufacture of toughened glass sheets for industrial use, highly toughened glass sheets, and highly heat-resistant toughened glass sheets.

1. A glass sheet quenching method comprising the steps of:
heating a glass sheet on carrying rollers to a predetermined temperature in a heating furnace;
radiating scattered microwaves or converged microwaves onto one side or both sides of the glass sheet through gaps between adjacent multiple air ducts of a quenching apparatus disposed with a substantially uniform spacing with respect to the carrying direction of the glass sheet, without hitting the carrying rollers; and
simultaneously with the radiation of the microwaves, blowing quenching air onto one side or both sides of the glass sheet from the air ducts, without hitting the carrying rollers.

2. The method of claim 1, wherein the frequency of the microwaves is 18 GHz to 300 GHz.

3. The method of claim 1, wherein the converged microwaves are scan-type converged microwaves scanned with an oscillating mirror.

4. The method of claim 1, wherein the converged microwaves are focused into a band of a length equivalent to the width of the glass sheet.

5. A quenching method according to claim 1, wherein the thickness of the glass sheet is 1.2 mm to 2.5 mm.

6. A glass sheet quenching apparatus installed downstream of a heating furnace for heating a glass sheet traveling on carrying rollers to a predetermined temperature, the apparatus comprising:
a chamber that is substantially dome-shaped and has its inner surface made a reflecting surface above and/or below the glass sheet;
a reflector provided in the vicinity of the center of the dome;
a waveguide provided in the chamber for guiding microwaves toward the reflector; and
multiple air ducts having between them gaps for allowing microwaves to pass through, disposed with a substantially uniform spacing in the travel direction of the glass sheet, for cooling with air the upper side and/or the lower side of the glass sheet,
wherein the microwaves are radiated, without hitting the carrying rollers, onto the glass sheet by the microwaves being primarily reflected with the reflector and secondarily reflected with the inner surface of the dome-shaped chamber.

7. The apparatus of claim 6, wherein the reflector has rotating means for rotating it about the center axis of the waveguide.

8. The apparatus of claim 6, wherein lower air ducts among the multiple air ducts are disposed directly below the carrying rollers, the lower air ducts each has a plurality of nozzles, and the nozzles are disposed inclinedly so that air blown out of them does not hit the carrying rollers.

9. The apparatus according to claim 6 wherein the reflecting surface comprises an irregularly reflecting surface.
